(19) United States
(12) Patent Application Publication
(10) Pub. No.: US 2015/0373566 A1
(43) Pub. Date: Dec. 24, 2015

(54) METHOD TO REDUCE THE TRANSMISSION DELAY FOR DATA PACKETS

(71) Applicant: QUALCOMM Incorporated, San Diego, CA (US)

(72) Inventors: Roshan PIUS, San Jose, CA (US); Alok MITRA, San Diego, CA (US); Shailesh MAHESHWARI, San Diego, CA (US); Vanitha Aravamudhan KUMAR, San Diego, CA (US); Muralidhar KRISHNAMOORTHY, San Diego, CA (US); Sriram Nagesh NOOKALA, San Diego, CA (US)

(21) Appl. No.: 14/743,670

(22) Filed: Jun. 18, 2015

Related U.S. Application Data
(60) Provisional application No. 62/014,629, filed on Jun. 19, 2014.

(51) Int. Cl. H04W 24/08; H04W 52/02; H04L 12/26

(52) U.S. Cl. CPC H04W 24/08; H04L 43/0852; H04W 52/0225

(57) ABSTRACT

A method, an apparatus, and a computer program product for wireless communication are provided. The apparatus may be a modem. The apparatus detects reception of a low latency data packet. The apparatus starts a data activity timer determined based on the detection of the reception of the low latency data packet. The apparatus sends a disable low power message from the apparatus to a host device to disable a low power state of a link between the apparatus and the host device based on a duration of the data activity timer.

### CROSS-REFERENCE TO RELATED APPLICATION(S)

This application claims the benefit of U.S. Provisional Application Ser. No. 62/014629, entitled “METHOD TO REDUCE THE TRANSMISSION DELAY FOR DATA PACKETS” and filed on Jun. 19, 2014, which is expressly incorporated by reference herein in its entirety.

### BACKGROUND

1. Field

The present disclosure relates generally to communication systems, and more particularly, to data packet communication.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus may be a modem. The apparatus detects reception of a low latency data packet. The apparatus starts a data activity timer determined based on the detection of the reception of the low latency data packet. The apparatus sends a disable low power message from the apparatus to a host device to disable a low power state of a link between the apparatus and the host device based on a duration of the data activity timer.

In an aspect, an apparatus includes means for detecting reception of a low latency data packet, means for starting a data activity timer determined based on the detection of the reception of the low latency data packet, and means for sending a disable low power message from the apparatus to a host device to disable a low power state of a link between the apparatus and the host device based on a duration of the data activity timer. The apparatus may be a modem.

In an aspect, an apparatus includes a memory and at least one processor coupled to the memory and configured to: detect reception of a low latency data packet, start a data activity timer determined based on the detection of the reception of the low latency data packet, and send a disable low power message from the apparatus to a host device to disable a low power state of a link between the apparatus and the host device based on a duration of the data activity timer. The apparatus may be a modem.

In an aspect, a computer-readable medium storing computer executable code for wireless communication, includes code for detecting reception of a low latency data packet, starting a data activity timer determined based on the detection of the reception of the low latency data packet, and sending a disable low power message from a modem to a host device to disable a low power state of a link between the modem and the host device based on a duration of the data activity timer. The computer-readable medium may be for a modem.

In another aspect of the disclosure, a method, a computer program product, and an apparatus are provided. The apparatus may be a host device. The apparatus receives a disable low power message from a modem, where the disable low power message is associated with reception of a low latency data packet. The apparatus disables, upon receiving the disable low power message, a low power state of a link between the modem and the apparatus based on a data activity timer. In an aspect, the data activity timer is determined based on the reception of the low latency data packet.

In an aspect, an apparatus includes means for receiving, at the apparatus, a disable low power message from a modem, where the disable low power message is associated with reception of a low latency data packet, and means for disabling, upon receiving the disable low power message, a low power state of a link between the modem and the apparatus based on a data activity timer, where the data activity timer is determined based on the reception of the low latency data packet. The apparatus may be a host device.

In an aspect, an apparatus includes a memory and at least one processor coupled to the memory and configured to: receive, at the apparatus, a disable low power message from a modem, where the disable low power message is associated with reception of a low latency data packet, and disable, upon receiving the disable low power message, a low power state of a link between the modem and the apparatus based on a data activity timer, where the data activity timer is determined based on the reception of the low latency data packet.

In an aspect, a computer-readable medium storing computer executable code for wireless communication, includes code for receiving, at a host device, a disable low power message from a modem, where the disable low power message is associated with reception of a low latency data packet, and disabling, upon receiving the disable low power message, a low power state of a link between the modem and the host device based on a data activity timer, where the data activity timer is determined based on the reception of the low latency data packet.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is an example diagram that illustrates a scenario where transitioning a communication link to a low power state causes delay in transmission of a subsequent data packet.

FIG. 8 is an example diagram illustrating a beginning stage of low latency data traffic.

FIG. 9 is an example diagram illustrating low latency data traffic in progress.

FIG. 10 is an example diagram illustrating low latency data traffic in progress.

FIG. 11 is a flow chart of a method of wireless communication.

FIG. 12 is a flow chart of a method of wireless communication, continuing from the flow chart of FIG. 11.

FIG. 13 is a flow chart of a method of wireless communication, continuing from the flow chart of FIG. 11 or the flow chart of FIG. 12.

FIG. 14 is a conceptual data flow diagram illustrating the data flow between different modules/means/components in an exemplary apparatus.

FIG. 15 is a diagram illustrating an example of a hardware implementation for an apparatus employing a processing system.

FIG. 16 is a flow chart of a method of wireless communication.

FIG. 17 is a flow chart of a method of wireless communication, continuing from the flow chart of FIG. 16.

FIG. 18 is a conceptual data flow diagram illustrating the data flow between different modules/means/components in an exemplary apparatus.

FIG. 19 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

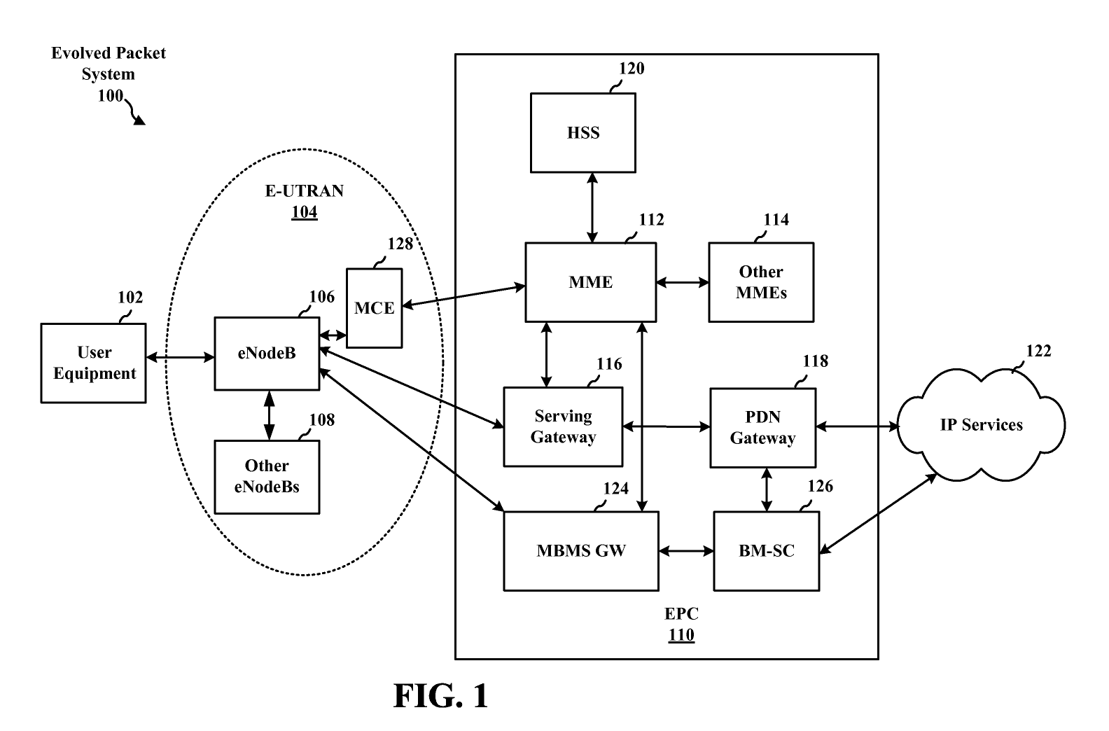

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a

Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

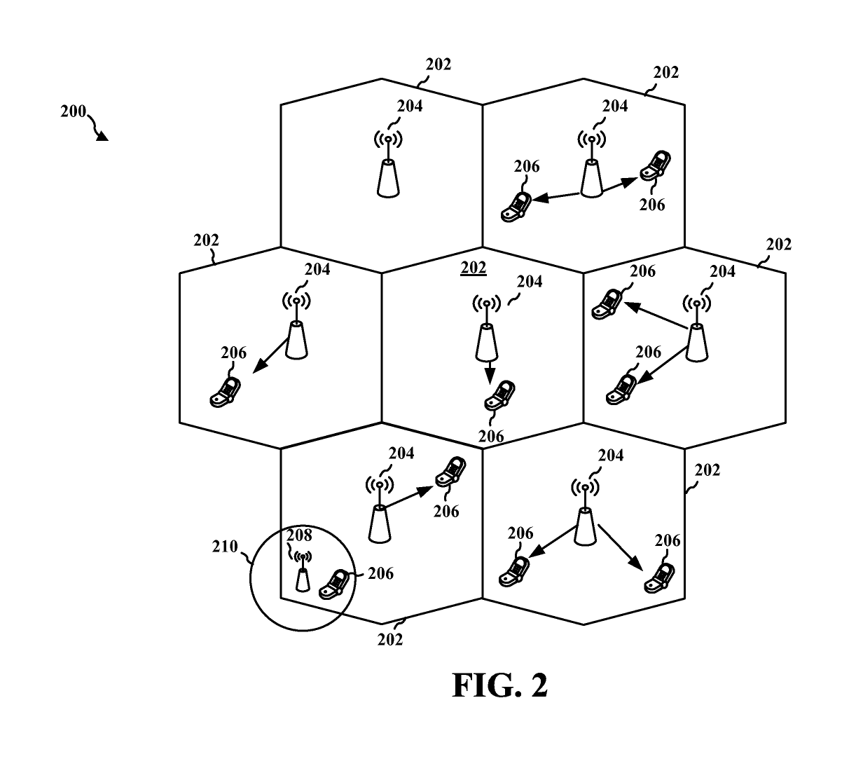

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

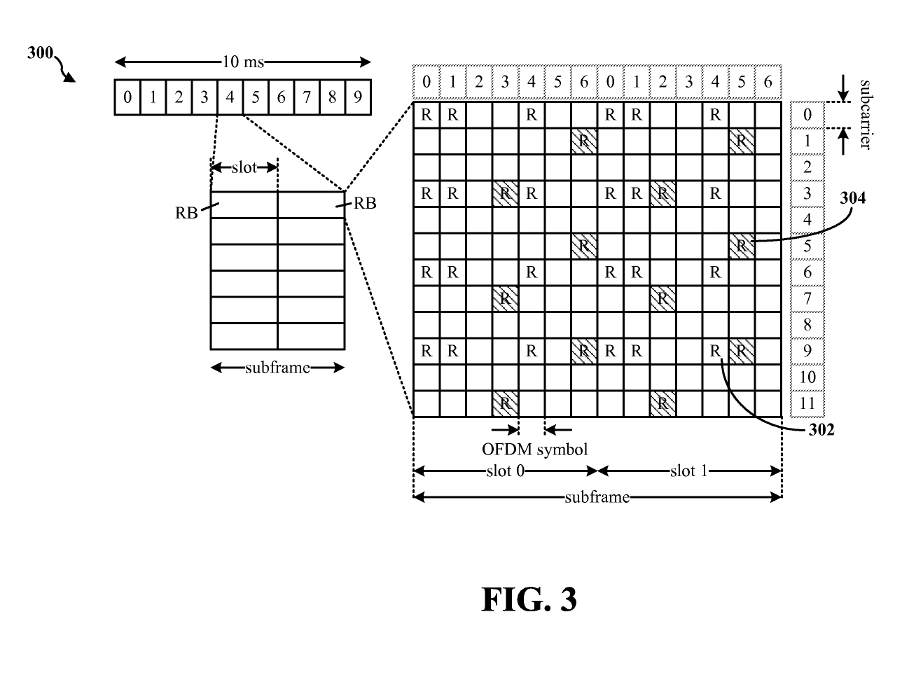

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

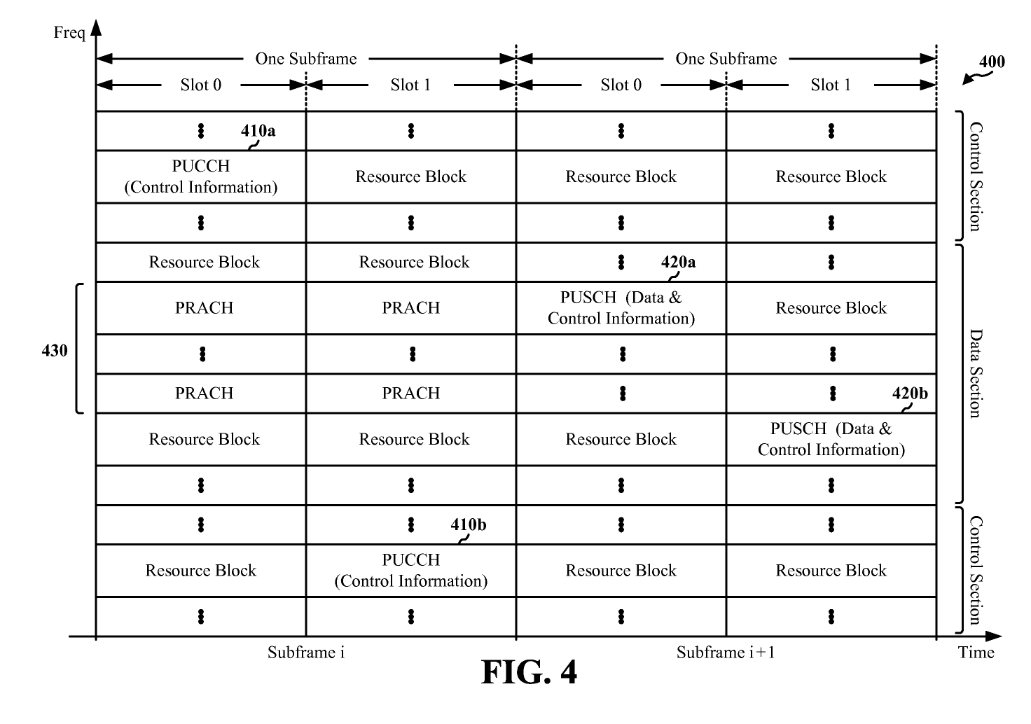

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

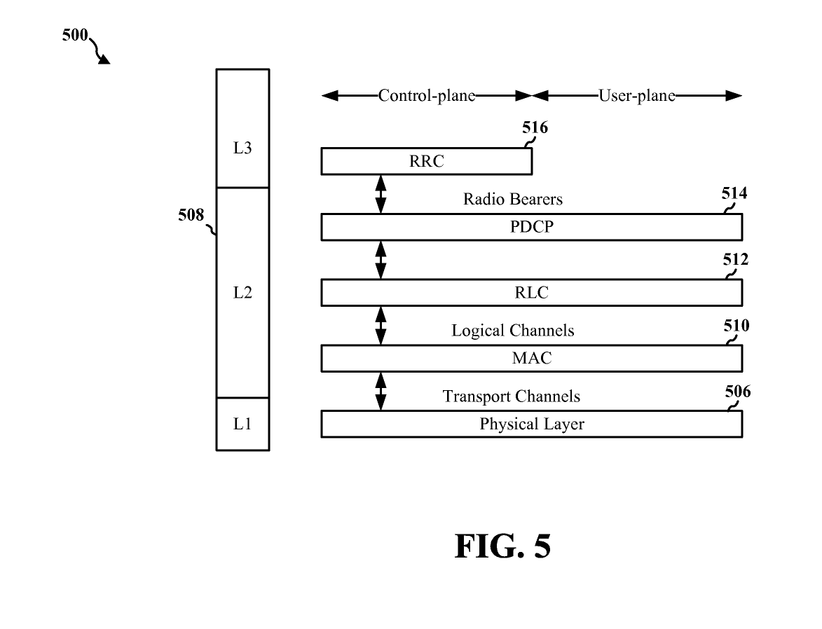

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

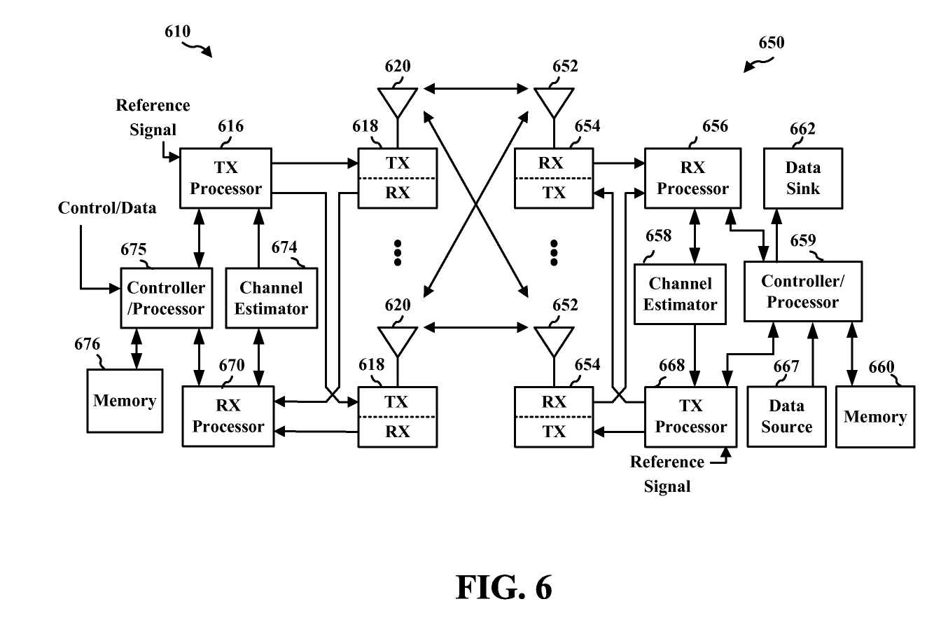

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

A modem receives a data packet from a network (e.g., eNB) and transmits the received data packet to a host device. The host device may be an application processor that is configured to process the data packet. In one example, the modem and the host device may be implemented within the same device. For example, a UE may implement a chip including a modem device and a chip including a host processor (e.g., an application processor). In another example, the modem may be implemented in a separate device from the host device. For example, the modem may be implemented in a router device, and the modem in the router device may be connected to a separate host device via a communication link.

When there is inactivity of data traffic in the communication link between a modem and a host device, the host device may transition the communication link to a low power state. In an aspect, consumption of power may be reduced by maintaining the communication link in the low power state during the inactivity of data traffic. For example, when multiple data packets are communicated between the modem and the host via a communication link (e.g., a transport bus) with inter-arrival time between packets greater than a few milliseconds, the communication link may transition to a low power state during time periods between arrivals of the multiple packets. Because the data traffic is inactive during the inter-arrival time periods between the arrivals of the multiple data packets, the communication link may transition from a normal power state to a low power state during such time periods. The communication link may include at least one of a peripheral component interconnect (PCI) link, a PCI express link (PCIe), a universal serial bus link, or a high speed inter chip (HSIC) link.

However, after the communication link transitions to the low power state, it generally takes a certain amount of time (e.g., link activation time) to bring the communication link out of the low power state to a normal power state. Because the data communication between the modem and the host device may not occur until after the communication link is at the normal power state, the link activation time to bring the communication link out of the low power state may cause latencies in data communication between the modem and the host device. Such latencies are undesirable for data communication with low latency requirements. For example, if data packets arrive frequently at the modem (with low latency between the data packets), it may not desirable to transition the communication link to the low power state during the inter-arrival time periods between the data packets. It is noted that the link activation time causes an additional delay in the transmission of the subsequent data packet from the modem to the host device because the communication link may not be used for data transmission until the link is brought out of the low power state back to the normal state.

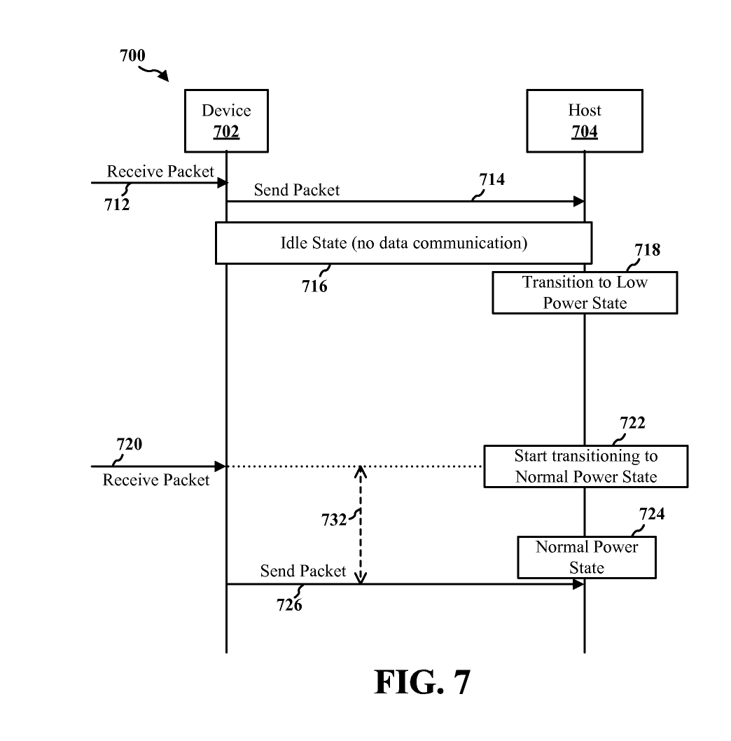

FIG. 7 is an example diagram 700 that illustrates a scenario where transitioning a communication link to a low power state causes delay in transmission of a subsequent data packet. The example diagram 700 includes communication between a device (e.g., a modem) 702 and a host 704. At 712, the device 702 receives a data packet from a network. At 714, the device 702 sends the received packet to the host 704. At 716, no communication takes place between the device 702 and the host 704, and thus a communication link between the device 702 and the host 704 is in an idle state. After the communication link between the device 702 and the host 704 stays in the idle state for some time, at 718, the host 704 transitions the communication link to a low power state. At 720, the device 702 receives a subsequent data packet from the network. At this time, because the communication link is in the low power state, at 722, the host 704 causes the communication link to transition back to a normal power state, in order to receive the subsequent data from the device 702. When the communication link is back in the normal power state at 724, the device 702 sends the subsequent data packet at 726 and the host 704 receives the subsequent data packet. However, a delay 732 between receiving the packet at 720 and sending the packet at 726 from the device 702 to the host 704 exists due to the time to transition the communication link from the low power state to the normal power state.

At least for the reasons stated above, an approach to reduce delays in data communication between the modem and the host device without significant impact on power consumption is desired. In particular, it may be desirable to minimize power transition (e.g., between the low power state and the normal power state) of the communication link between the modem and the host device for certain types of data communication, such as the low latency data communication.

As discussed supra, the communication link between a modem and a host device may transition to a low power state if the communication link stays idle during an inter-arrival time period between communications of data packets. However, for a certain type of data communication, transitioning to the low power state may not be desirable, especially if the data communication is low latency data communication with a short time delay (e.g., short inter-arrival time) between data packets. According to an aspect of the disclosure, when a modem receives a data packet from a network (e.g., eNB), the modem may determine a type of data communication from the network. Based on the type of data communication, the modem may determine whether to disable a low power state of the communication link between the modem and the host device. For example, if the modem detects that the type of data received from the network is a low latency data packet, the modem may determine to disable transitioning to the low power state of the communication link.

Following approaches may be implemented to identify a type of data transmission (e.g., the low latency data communication). These approaches may be implemented separately or in combination. According to one approach, a modem may implement one or more packet filters to filter incoming data packets. By filtering the incoming data packets based on the packet filters, the modem may detect a type of data transmission. For example, a data packet being filtered by one packet filter may indicate that such data packet is a low latency data packet. Another data packet being filtered by another packet filter may indicate that such data packet is a high latency data packet. Thus, by determining which packet filter filters the received data packet, the modem may determine a type of the received data packet associated with the packet filter. It is noted that the modem may receive filter information (e.g., filter specifications) from the host device and/or the network to install one or more packet filters at the modem.

According to another approach, the modem may receive (from the host device or the network) packet information on initiation of a certain type of data communication such as low latency data communication. In such an approach, the host may detect the presence of the low latency data communication, and subsequently send the modem the packet information about the low latency data communication. For example, when the host device detects low latency data communication, the host device may send the packet information about the low latency data communication via control signaling to the modem. Thus, upon receiving such packet information from the host device or the network, the modem may identify the low latency data communication.

In one aspect of the disclosure, if the modem determines that disabling a low power state of the communication link is desired for a certain type of the data communication (e.g. low latency data communication), the modem may determine a data activity timer that indicates activity of data communication, and subsequently start the data activity timer. Upon starting the data activity timer, the modem may send a disable indication to the host device to disable transitioning the communication link to the low power state. When the host device receives the disable indication from the modem, the host device disables transitioning the communication link to the low power state (e.g., by refraining from causing the communication link to transition to the low power state). If the modem detects reception of another low latency data before the data activity timer expires, the modem starts another data activity timer, and the low power state transitioning remains disabled. If the data activity timer expires before the modem receives another low latency data packet, then the modem may send an enable indication to the host device to enable the low power state transitioning.

In one aspect, the disable indication may be used to deactivate an inactivity timer at the host device, in order to prevent the host device from causing the communication link to transition to the low power state. The host device may implement an inactivity timer that indicates time duration of inactivity of the communication link to lapse before transitioning the communication link to the low power state. The host device sets the inactivity timer when the host device detects inactivity (e.g., no data traffic) in the communication link. The host device deactivates the inactivity timer when the host device determines presence of data traffic in the communication link. If the communication link stays inactive for the duration of the inactivity timer, and thus the inactivity timer expires, the host device may enable transitioning the communication link to the low power state upon the expiration of the inactivity timer. Thus, if the modem sends a disable indication to the host device before expiration of the inactivity timer, the host device deactivates the inactivity timer, and thus disables transitioning the communication link to the low power state. After deactivation of the inactivity timer by the disable indication, if the modem sends an enable indication to the host device, the host device may enable the low power state transitioning and thus may activate the inactivity timer, such that the communication link may transition to the low power state upon expiration of the inactivity timer.

The duration of the data activity timer may be determined according to at least one of the following approaches. These approaches may be implemented separately or in combination. According to one approach, the modem may determine the duration of the data activity timer based on timer information received from the host device. For example, when reception of a low latency data packet is detected, the host device may send the timer information to the modem, such that the modem may determine the data activity timer based on the timer information. The duration of the data activity timer based on the timer information may be greater than or equal to the duration of the inactivity timer set by the host device.

According to another approach, the modem may determine a type of a first data packet received at the modem and a type of a second data packet subsequently received at the modem from the network. The modem may determine the type of the first data packet and the type of the second data packet based on one or more filters installed at the modem. For example, the modem may determine the first and second data packets may be low latency data packets if the first and second data packets are filtered by data filters indicating low latency data. Based on the type of the first data packet and the type of the second data packet, the modem estimates a packet delay between data packets for subsequent packets. The modem may determine the data activity timer based on the estimated packet delay between the data packets. For example, the duration of the data activity timer may be greater than or equal to a duration of the estimated packet delay.

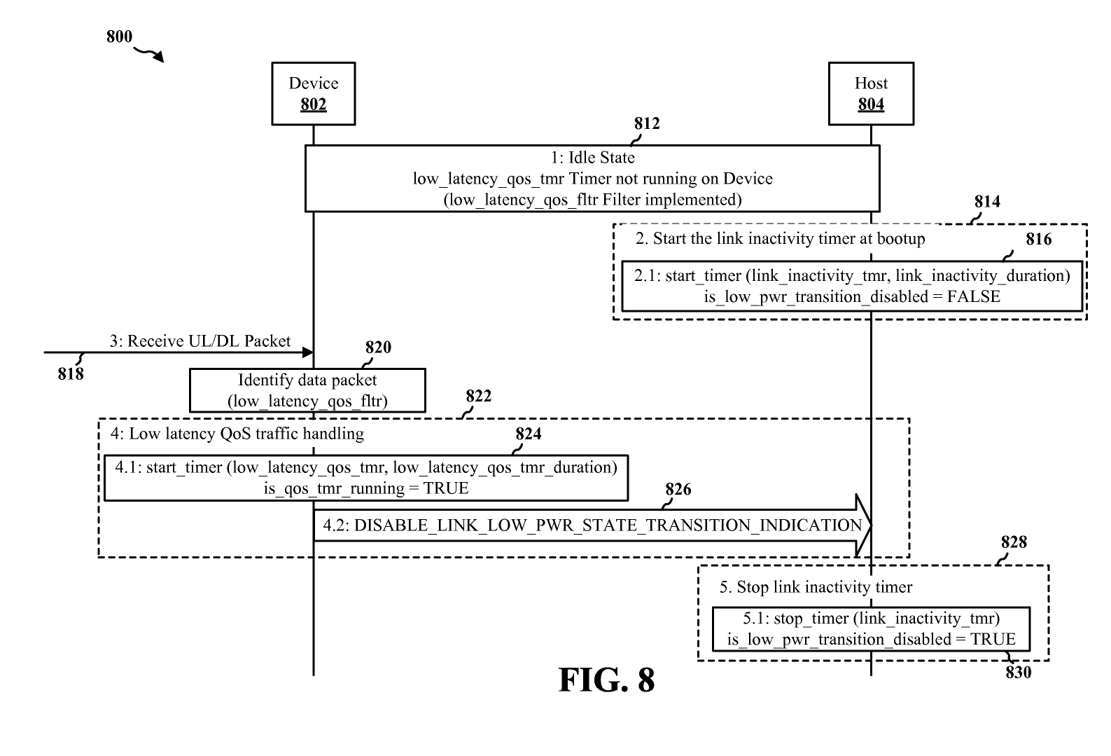

FIG. 8 is an example diagram 800 illustrating a beginning stage of low latency data traffic. The example diagram 800 involves communication between a device (e.g., a modem) 802 and a host 804. At 812, a communication link between the device 802 and the host 804 is in an idle state, where no data communication traffic is present in the communication link. At 812, the device is not running a data activity timer such as a low latency data activity timer (e.g., low_latency_qos_tmr). In one aspect, the device 802 may implement one or more low latency data filters (e.g., low-latency_qos_fltr) to detect low latency data packets based on filter information received from the host 804. At 814, the host 804 starts a link inactivity timer process, as the communication link is in the idle state. The host 804 may start at 816 a link inactivity timer (e.g., link_inactivity_tmr) having a link inactivity timer duration (e.g., link_inactivity_duration). At 816, the host 804 does not disable transition to the low power state when starting the link inactivity timer.

At 818, the device 802 receives a data packet. At 820, the device 802 identifies the data packet. In an aspect, the device 802 may identify the data packet by determining a type of the data packet (e.g., by determining whether the data packet is a low latency data). In one aspect, the device 802 may use a low latency data filter to determine whether the data packet is a low latency data packet. In another aspect, the host 804 may provide the device 802 information to identify whether the data packet is a low latency data packet. At 822, upon identifying a low latency data packet, a low latency data traffic handling is performed. In particular, at 824, the device 802 starts a data activity timer (e.g., low_latency_qos_timer) with the data activity timer duration (e.g., low_latency_qos_tmr_duration), and thus a status of the data activity timer indicates that the data activity timer is running While the data activity timer is running, transitioning the communication link to the low power state should be disabled. At 826, upon starting the data activity timer, the device 802 sends a disable indication message (e.g., DISABLE_LINK_LOW_PWR_STATE_TRANSITION_INDICATION) to disable transitioning the link to the low power state to the host 804. At 828, upon receiving the disable indication message to disable transitioning the link to the low power state, the host 804 performs a process to stop the link inactivity timer. In particular, at 830, the host 804 stops the link inactivity timer (e.g., link_inactivity_tmr), and disables transitioning the communication link to the low power state.

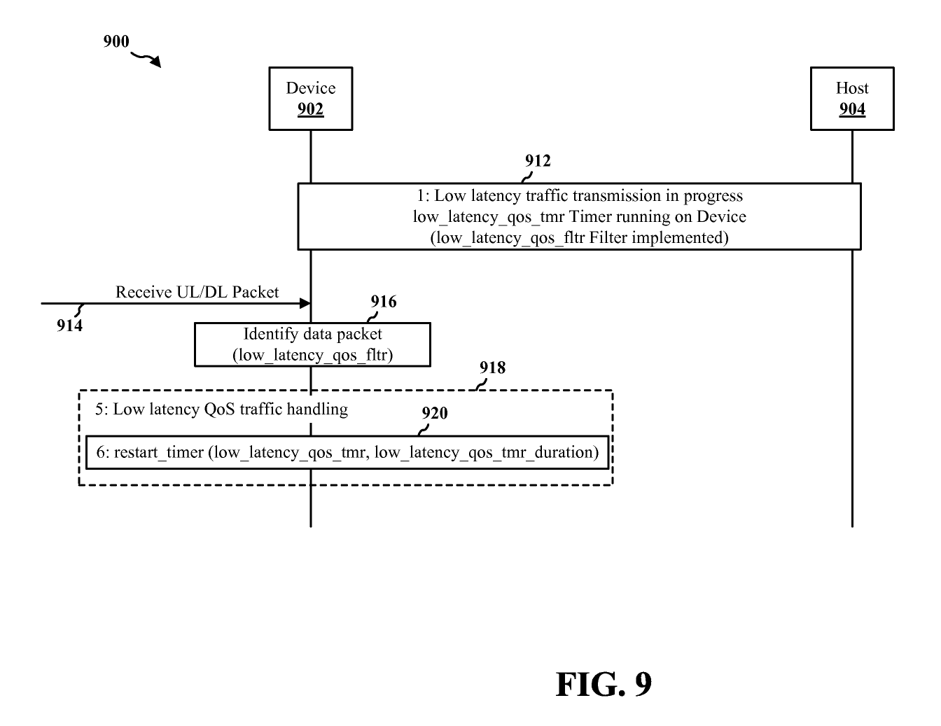

FIG. 9 is an example diagram 900 illustrating low latency data traffic in progress. The example diagram 900 involves communication between a device (e.g., a modem) 902 and a host 904. The device 902 and the host 904 may be equivalent to the device 802 and the host 804, respectively. The example diagram 900 may take place after receiving a low latency data packet (e.g., after the example diagram 800 of FIG. 8). At 912, a low latency traffic transmission is in progress between the device 902 and the host 904. At 912, the device 902 is running a data activity timer (e.g., low_latency_qos_tmr). While the data activity timer is running, transitioning the communication link to the low power state should be disabled. At 912, in an aspect, the device 902 may implement one or more low latency data filters (e.g., low-latency_qos_fltr) to detect low latency data packets based on filter information received from the host 904. At 914, the device 902 receives a (subsequent) data packet. At 916, the device 902 identifies the data packet. In an aspect, the device 902 may identify the data packet by determining a type of the data packet. In one aspect, the device 902 may use a low latency data filter to determine whether the data packet is a low latency data packet. In another aspect, the host 904 may provide the device 902 information to identify whether the data packet is a low latency data packet. At 918, the device 902 performs low latency data traffic handling. In particular, at 920, the device 902 restarts the data activity timer (e.g., low_latency_qos_tmr) with a data activity timer duration (e.g., low_latency_qos_tmr_duration) based on the reception of the low latency data packet. In an aspect, upon restarting the data activity timer at 920, transitioning the communication link to the low power state is disabled for the data activity timer duration.

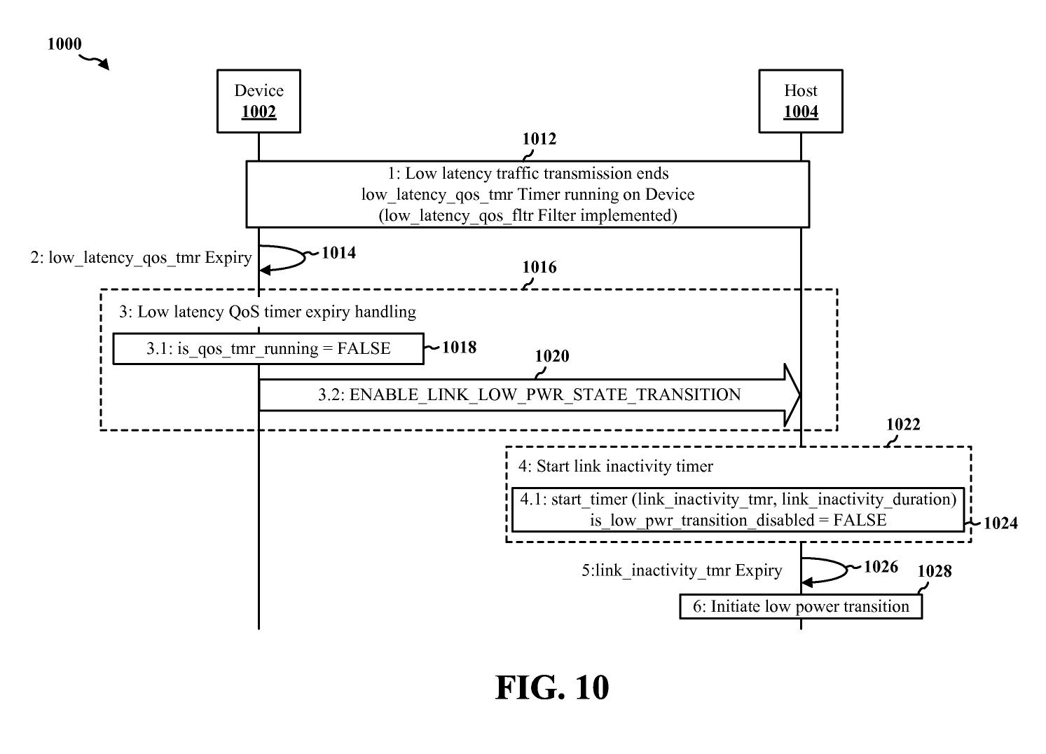

FIG. 10 is an example diagram 1000 illustrating low latency data traffic in progress. The example diagram 1000 involves communication between a device (e.g., a modem) 1002 and a host 1004. In an aspect, the device 1002 and the host 1004 may be equivalent to the device 802 and the host 804, respectively. In an aspect, the device 1002 and the host 1004 may be equivalent to the device 902 and the host 904, respectively. The example diagram 1000 may take place after receiving a low latency data packet (e.g., after the example diagram 800 of FIG. 8 or after the example diagram 900 of FIG. 9). At 1012, the low latency traffic transmission between the device 1002 and the host 1004 ends. At 1012, the device 1002 is running a data activity timer (e.g., low-latency_qos_tmr). While the data activity timer is running, transitioning the communication link to the low power state should be disabled. At 1012, in an aspect, the device 1002 may implement one or more low latency data filters (e.g., low-latency_qos_fltr) to detect low latency data packets based on filter information received from the host 1004. At 1014, a data activity timer (e.g., low_latency_qos_tmr) at the device 1002 expires. Upon expiration of the data activity timer, a low latency data activity timer expiry handling is performed at 1016. In particular, at 1018, the device 1002 determines that the data activity timer is no longer running. At 1020, upon determination that the data activity timer is not running, the device 1002 sends the host 1004 an enable indication message (e.g., ENABLE_LINK_LOW_PWR_STATE_TRANSITION) to enable transitioning the communication link to the low power state. At 1022, upon receiving the enable indication message, the host 1004 starts a process to start the link inactivity timer. In particular, at 1024, the host 1004 starts the link inactivity timer (e.g., link_inactivity_tmr) with a link inactivity timer duration (e.g., link_inactivity_duration), and indicates that transitioning the communication link to the low power state is not disabled. At 1026, after the link inactivity timer duration has passed, the link inactivity timer expires at the host 1004. At 1028, upon expiration of the link inactivity timer, the host 1004 initiates transitioning the communication link to the low power state.

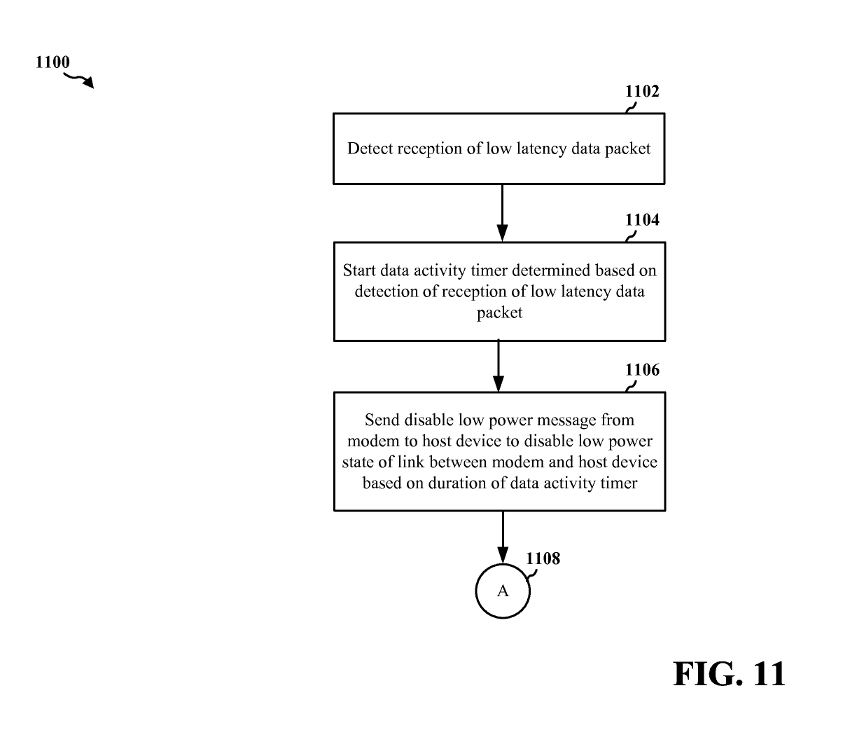

FIG. 11 is a flow chart 1100 of a method of wireless communication. The method may be performed by a modem (e.g., the modem, the device 802, the apparatus 1402/1402′). The modem may be implemented in a UE. At 1102, the modem detects reception of a low latency data packet. At 1104, the modem starts a data activity timer determined based on the detection of the reception of the low latency data packet. At 1106, the modem sends a disable low power message from the modem to a host device to disable a low power state of a link between the modem and the host device based on a duration of the data activity timer. At 1108, the modem may perform additional method features. In an aspect, the link includes at least one of a PCI link, a PCIe, a universal serial bus link, or an HSIC link. In an aspect, the low latency data packet is a QoS data packet. As discussed supra, for example, if the modem detects that the type of data received from the network is a low latency data packet, the modem may determine to disable transitioning to the low power state of the communication link. As discussed supra, for example, if the modem determines that disabling the communication link is desired for the type of the data communication (e.g. low latency data communication), the modem may determine a data activity timer that indicates activity of data communication. As discussed supra, for example, upon determining the data activity timer, the modem may send a disable indication to the host device to disable transitioning the communication link to the low power state.

In an aspect, the modem detects the reception of the low latency data packet by matching the low latency data packet with a corresponding one of at least one packet filter, and determining packet information on the low latency data packet based on the matching. In such an aspect, the data activity timer is determined based on the determined packet information. In such an aspect, the at least one packet filter is implemented at the modem based on filter information received from at least one of the host device or a network. As discussed supra, for example, by filtering the incoming data packets based on the packet filters, the modem may detect a type of data transmission. As discussed supra, for example, a data packet being filtered by one packet filter may indicate that such data packet is a low latency data packet. As discussed supra, the modem may receive filter information (e.g., filter specifications) from the host device and/or the network to install one or more packet filters at the modem. In an aspect, the data activity timer is determined by determining a packet delay between a previous low latency data packet and the low latency data packet based on the determined packet information. In such an aspect, the data activity timer is determined based on the determined packet delay. In such an aspect, the duration of the data activity timer is greater than or equal to a duration of the determined packet delay. As discussed supra, for example, based on the type of the first data packet and the type of the second data packet, the modem estimates a packet delay between data packets for subsequent packets. As discussed supra, for example, the modem may determine the data activity timer based on the estimated packet delay between the data packets.

In another aspect, the modem detects the reception of the low latency data packet by receiving, from a host device, packet information about the reception of the low latency data packet. In such an aspect, the data activity timer is determined based on the received packet information. As discussed supra, for example, when the host device detects low latency data communication, the host device may send the packet information about the low latency data communication. As discussed supra, for example, upon receiving such packet information from the host device or the network, the modem may identify the low latency data communication.

In an aspect, the data activity timer is determined by receiving timer information associated with the low latency data packet from the host device, and determining a duration of the data activity timer based on the timer information. In such an aspect, the duration of the data activity timer is greater than or equal to the duration of an inactivity timer set by the host device, where expiration of the inactivity timer indicates inactivity in the link for a duration of the inactivity timer and causes the link to transition to the low power state. As discussed supra, for example, when reception of a low latency data packet is detected, the host device may send the timer information to the modem, such that the modem may determine the data activity timer based on the timer information. As discussed supra, for example, the duration of the data activity timer based on the timer information may be greater than or equal to the duration of the inactivity timer set by the host device. As discussed supra, for example, if the communication link stays inactive for the duration of the inactivity timer, and thus the inactivity timer expires, the host device may enable transitioning the communication link to the low power state upon the expiration of the inactivity timer.

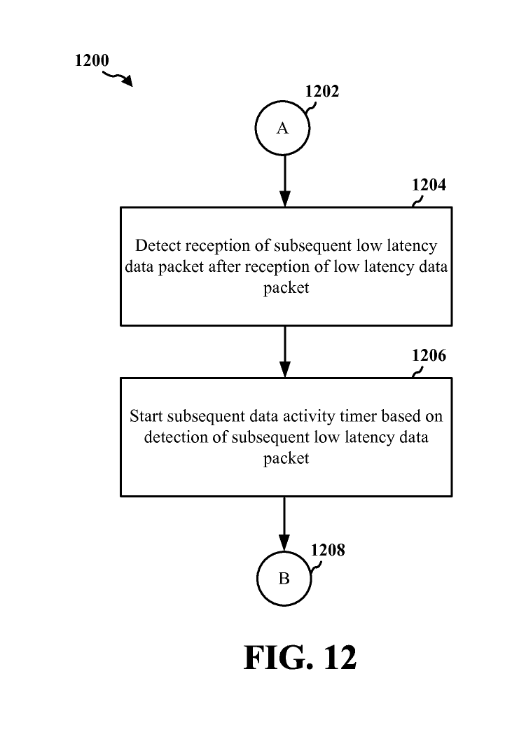

FIG. 12 is a flow chart 1200 of a method of wireless communication, continuing from the flow chart 1100 of FIG. 11. The method may be performed by a modem (e.g., the modem, the device 802, the apparatus 1402/1402′). At 1202, the method performed by the modem may be continued from 1108 of FIG. 11. At 1204, the modem detects reception of a subsequent low latency data packet after the reception of the low latency data packet. At 1206, the modem starts a subsequent data activity timer based on the detection of the subsequent low latency data packet. At 1208, the modem may perform additional method features. As discussed supra, referring back to FIG. 9, when a low latency traffic transmission is in progress between the device 902 and the host 904, the device 902 receives a (subsequent) data packet at 914, and identifies the data packet. As discussed supra, referring back to FIG. 9, at 920, the device 902 restarts the data activity timer with a data activity timer duration based on the reception of the low latency data packet.

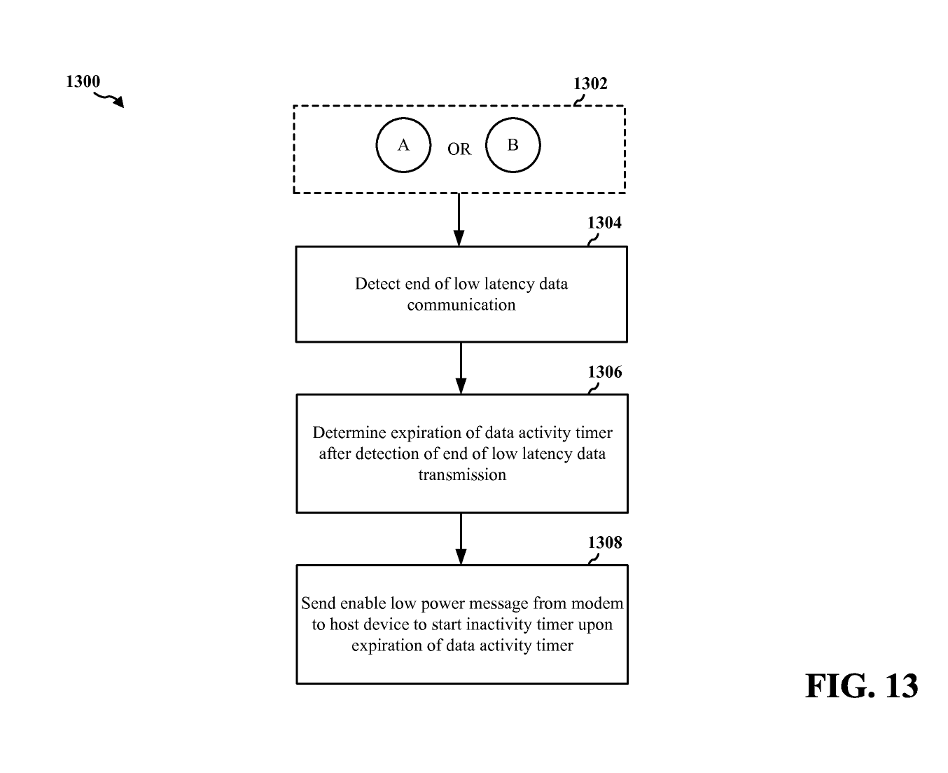

FIG. 13 is a flow chart 1300 of a method of wireless communication, continuing from the flow chart 1100 of FIG. 11 or the flow chart 1200 of FIG. 12. The method may be performed by a modem (e.g., the modem, the device 802, the apparatus 1402/1402′). At 1302, the method performed by the modem may be continued from 1108 of FIG. 11 or from 1208 of FIG. 12. At 1304, the modem detects an end of low latency data communication. At 1306, the modem determines expiration of the data activity timer after the detection of the end of the low latency data transmission. At 1306, the modem sends an enable low power message from the modem to the host device to start an inactivity timer upon expiration of the data activity timer. In an aspect, the expiration of the inactivity timer indicates inactivity in the link for a duration of the inactivity timer and causes the link to transition to the low power state. As discussed supra, referring back to FIG. 10, after the low latency traffic transmission between the device 1002 and the host 1004 ends, at 1014, a data activity timer at the device 1002 expires. As discussed supra, referring back to FIG. 10, after expiration of the data activity timer, the device 1002 sends the host 1004 an enable indication message to enable transitioning the communication link to the low power state.

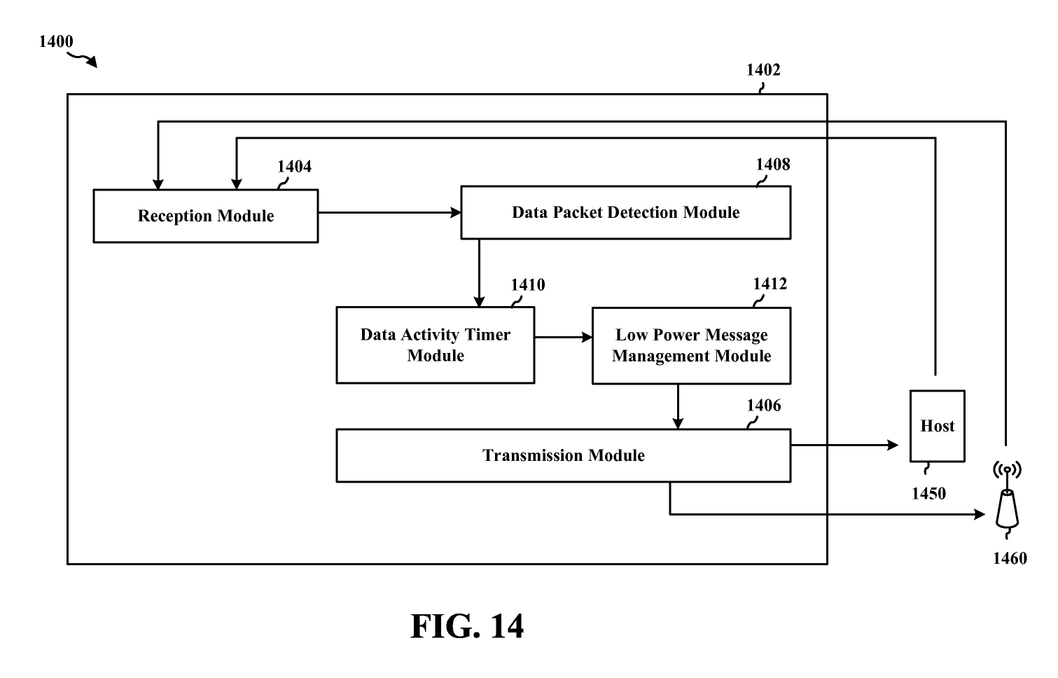

FIG. 14 is a conceptual data flow diagram 1400 illustrating the data flow between different modules/means/components in an exemplary apparatus 1402. The apparatus may be a modem. In an aspect, the modem may be implemented in a UE. The apparatus includes a reception module 1404, a transmission module 1406, data packet detection module 1408, data activity timer module 1410, and a low power message management module 1412.

The data packet detection module 1408 detects reception of a low latency data packet via the reception module 1404. The data activity timer module 1410 starts a data activity timer determined based on the detection of the reception of the low latency data packet. The low power message management module 1412 sends via the transmission module 1406 a disable low power message from the apparatus to a host device 1450 to disable a low power state of a link between the apparatus and the host device 1450 based on a duration of the data activity timer.

In an aspect, the data packet detection module 1408 detects the reception of the low latency data packet by matching the low latency data packet with a corresponding one of at least one packet filter, and determining packet information on the low latency data packet based on the matching. In such an aspect, the data activity timer is determined via the data activity timer module 1410 based on the determined packet information. In such an aspect, the at least one packet filter is implemented at the apparatus at the data packet detection module 1408 based on filter information received from at least one of the host device 1450 or an eNB 1460. In an aspect, the data activity timer is determined via the data activity timer module 1410 by determining a packet delay between a previous low latency data packet and the low latency data packet based on the determined packet information. In such an aspect, the data activity timer is determined based on the determined packet delay. In such an aspect, the duration of the data activity timer is greater than or equal to a duration of the determined packet delay.

In another aspect, the data packet detection module 1408 detects the reception of the low latency data packet by receiving via the reception module 1404, from the host device 1450, packet information about the reception of the low latency data packet. In such an aspect, the data activity timer is determined via the data packet detection module 1408 based on the received packet information.

In an aspect, the data activity timer is determined via the data packet detection module 1408 by receiving timer information associated with the low latency data packet from the host device 1450, and determining a duration of the data activity timer based on the timer information. In such an aspect, the duration of the data activity timer is greater than or equal to the duration of an inactivity timer set by the host device 1450, where expiration of the inactivity timer indicates inactivity in the link for a duration of the inactivity timer and causes the link to transition to the low power state.

The apparatus may include additional modules that perform each of the steps of the algorithm in the aforementioned flow charts of FIGS. 11-13. As such, each step in the aforementioned flow charts of FIGS. 11-13 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

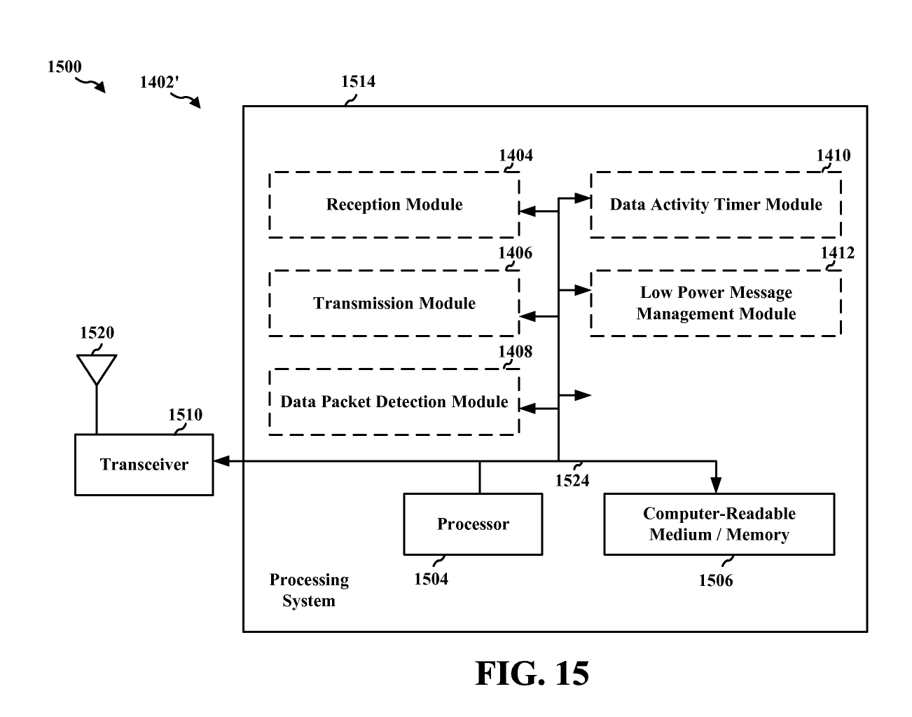

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware modules, represented by the processor 1504, the modules 1404, 1406, 1408, 1410, 1412, and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception module 1404. In addition, the transceiver 1510 receives information from the processing system 1514, specifically the transmission module 1406, and based on the received information, generates a signal to be applied to the one or more antennas 1520. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system further includes at least one of the modules 1404, 1406, 1408, 1410, and 1412. The modules may be software modules running in the processor 1504, resident/stored in the computer readable medium/memory 1506, one or more hardware modules coupled to the processor 1504, or some combination thereof. The processing system 1514 may be a component of the UE 650 and may include the memory 660 and/or at least one of the TX processor 668, the RX processor 656, and the controller/processor 659.

In one configuration, the apparatus 1402/1402′ for wireless communication includes means for detecting reception of a low latency data packet, means for starting a data activity timer determined based on the detection of the reception of the low latency data packet, and means for sending a disable low power message from a modem to a host device to disable a low power state of a link between the modem and the host device based on a duration of the data activity timer. The apparatus 1402/1402′ further includes means for detecting reception of a subsequent low latency data packet after the reception of the low latency data packet and means for starting a subsequent data activity timer based on the detection of the subsequent low latency data packet. The apparatus 1402/1402′ further includes means for detecting an end of low latency data communication, means for determining expiration of the data activity timer after the detection of the end of the low latency data transmission, and means for sending an enable low power message from the modem to the host device to start an inactivity timer upon expiration of the data activity timer, where expiration of the inactivity timer indicates inactivity in the link for a duration of the inactivity timer and causes the link to transition to the low power state. The aforementioned means may be one or more of the aforementioned modules of the apparatus 1402 and/or the processing system 1514 of the apparatus 1402′ configured to perform the functions recited by the aforementioned means. As described supra, the processing system 1514 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

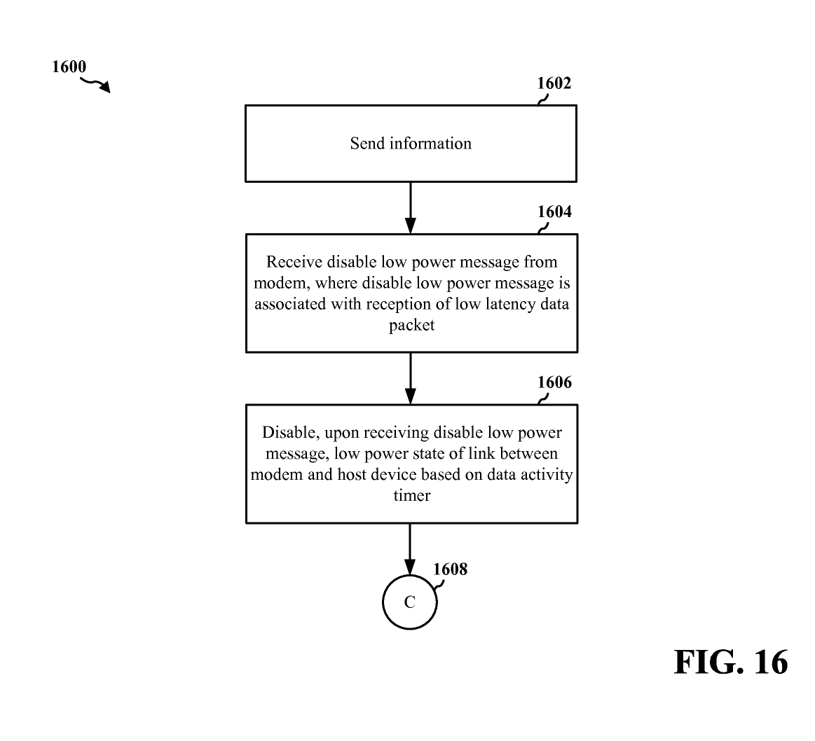

FIG. 16 is a flow chart 1600 of a method of wireless communication. The method may be performed by a host device (e.g., the host, the host 904, the apparatus 1802/1802′). The host device may be implemented in a UE or in a device that is separate from a UE. At 1602, the host device sends information. In an aspect, the host device may send filter information to the modem to implement at least one packet filter at the modem. In an aspect, the host device may send packet information about the reception of the low latency data packet to the modem. In an aspect, the host device may send timer information associated with the low latency data packet to the modem. At 1604, the host device receives a disable low power message from a modem, where the disable low power message is associated with reception of a low latency data packet. At 1606, the host device disables, upon receiving the disable low power message, a low power state of a link between the modem and the host device based on a data activity timer. In an aspect, the data activity timer is determined based on the reception of the low latency data packet. At 1608, the modem may perform additional method features. In an aspect, the link includes at least one of a PCI link, a PCIe, a universal serial bus link, or an HSIC link. In an aspect, the low latency data packet is a QoS data packet.

As discussed supra, for example, if the modem determines that disabling the communication link is desired for the type of the data communication (e.g. low latency data communication), the modem may determine a data activity timer that indicates activity of data communication. As discussed supra, for example, upon determining the data activity timer, the modem may send a disable indication to the host device to disable transitioning the communication link to the low power state. As discussed supra, for example, when the host device receives the disable indication from the modem, the host device disables transitioning the communication link to the low power state. As discussed supra, for example, by filtering the incoming data packets based on the packet filters, the modem may detect a type of data transmission. As discussed supra, for example, a data packet being filtered by one packet filter may indicate that such data packet is a low latency data packet. As discussed supra, the modem may receive filter information (e.g., filter specifications) from the host device and/or the network to install one or more packet filters at the modem.

In an aspect, the data activity timer is determined based on matching between the low latency data packet and a corresponding one of the at least one packet filter at the modem. In such an aspect, the data activity timer is determined based further on a packet delay between a previous low latency data packet and the low latency data packet. In such an aspect, the duration of the data activity timer is greater than or equal to a duration of the packet delay. As discussed supra, for example, based on the type of the first data packet and the type of the second data packet, the modem estimates a packet delay between data packets for subsequent packets. As discussed supra, for example, the modem may determine the data activity timer based on the estimated packet delay between the data packets.

In an aspect, the data activity timer is determined based on the packet information. As discussed supra, for example, when the host device detects low latency data communication, the host device may send the packet information about the low latency data communication. As discussed supra, for example, upon receiving such packet information from the host device or the network, the modem may identify the low latency data communication. In an aspect, a duration of the data activity timer is determined based on the timer information. In such an aspect, the duration of the data activity timer is greater than or equal to the duration of an inactivity timer set by the host device. In an aspect, expiration of the inactivity timer indicates inactivity in the link for a duration of the inactivity timer and causes the link to transition to the low power state. As discussed supra, for example, when reception of a low latency data packet is detected, the host device may send the timer information to the modem, such that the modem may determine the data activity timer based on the timer information. As discussed supra, for example, the duration of the data activity timer based on the timer information may be greater than or equal to the duration of the inactivity timer set by the host device. As discussed supra, for example, if the communication link stays inactive for the duration of the inactivity timer, and thus the inactivity timer expires, the host device may enable transitioning the communication link to the low power state upon the expiration of the inactivity timer.

In an aspect, the host device disables the low power state of the link by stopping an inactivity timer to prevent the link from transitioning to the low power state. In an aspect, expiration of the inactivity timer indicates inactivity in the link for a duration of the inactivity timer and causes the link to transition to the low power state. As discussed supra, for example, the disable indication may be used to deactivate an inactivity timer at the host device, in order to prevent the host device from causing the communication link to transition to the low power state.

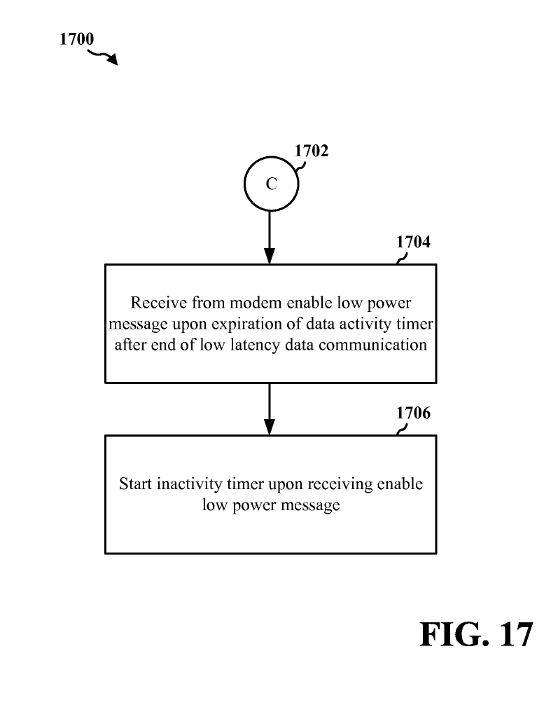

FIG. 17 is a flow chart 1700 of a method of wireless communication, continuing from the flow chart 1600 of FIG. 16. The method may be performed by a host device (e.g., the host, the host 904, the apparatus 1802/1802′). The host device may be implemented in a UE or in a device that is separate from a UE. At 1702, the method performed by the host device may be continued from 1608 of FIG. 16. At 1704, the host device receives from the modem an enable low power message upon expiration of the data activity timer after an end of low latency data communication. At 1706, the host device starts an inactivity timer upon receiving the enable low power message. In an aspect, expiration of the inactivity timer indicates inactivity in the link for a duration of the inactivity timer and causes the link to transition to the low power state. As discussed supra, referring back to FIG. 10, after expiration of the data activity timer, the device 1002 sends the host 1004 an enable indication message to enable transitioning the communication link to the low power state. As discussed supra, referring back to FIG. 10, upon receiving the enable indication message, the host 1004 starts the link inactivity timer with a link inactivity timer duration, and indicates that transitioning the communication link to the low power transition is not disabled.

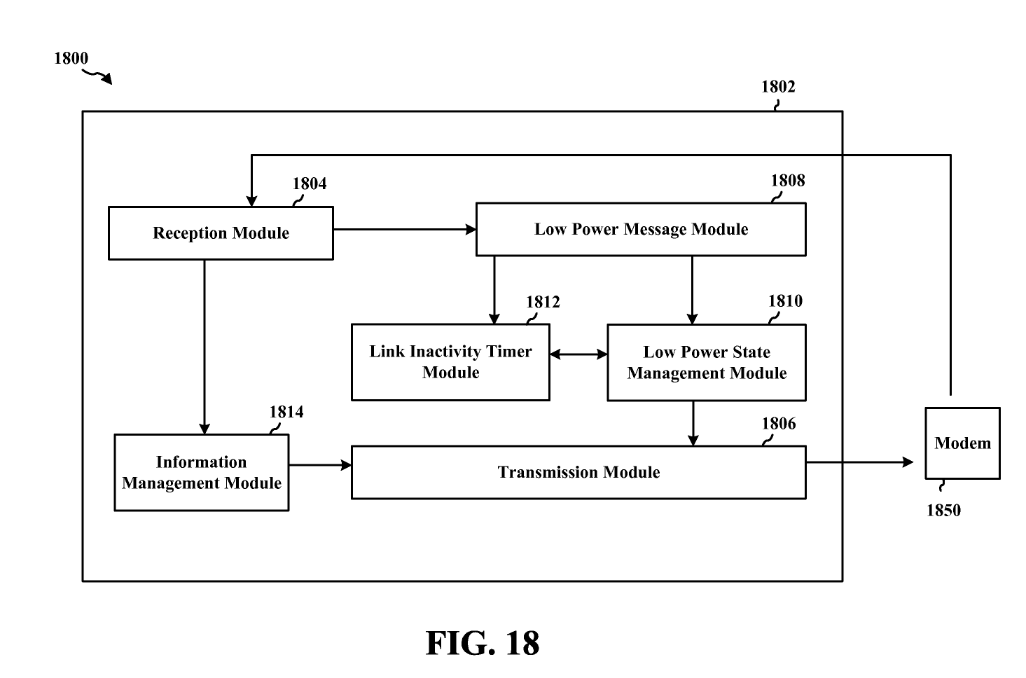

FIG. 18 is a conceptual data flow diagram 1800 illustrating the data flow between different modules/means/components in an exemplary apparatus 1802. The apparatus may be a host device. The host device may be implemented in a UE. The apparatus includes a reception module 1804, a transmission module 1806, a low power message module 1808, a low power state management module 1810, a link inactivity timer module 1812, and an information management module 1814.

The low power message module 1808 receives via the reception module 1804 a disable low power message from a modem 1850, where the disable low power message is associated with reception of a low latency data packet. The low power state management module 1810 disables, upon receiving the disable low power message, a low power state of a link between the modem and the host device based on a data activity timer. In an aspect, the data activity timer is determined based on the reception of the low latency data packet. In an aspect, the link includes at least one of a PCI link, a PCIe, a universal serial bus link, or an HSIC link. In an aspect, the low latency data packet is a QoS data packet.

In an aspect, the low power state management module 1810 disables the low power state of the link by stopping an inactivity timer via the link inactivity timer module 1812 to prevent the link from transitioning to the low power state. In an aspect, expiration of the inactivity timer indicates inactivity in the link for a duration of the inactivity timer and causes the link to transition to the low power state.

In an aspect, the information management module 1814 sends via the transmission module 1806 filter information to the modem to implement at least one packet filter at the modem 1850. In such an aspect, the data activity timer is determined based on matching between the low latency data packet and a corresponding one of the at least one packet filter at the modem. In such an aspect, the data activity timer is determined based further on a packet delay between a previous low latency data packet and the low latency data packet. In such an aspect, a duration of the data activity timer is greater than or equal to a duration of the packet delay.

In an aspect, the information management module 1814 sends via the transmission module 1806 packet information about the reception of the low latency data packet to the modem 1850. In such an aspect, the data activity timer is determined based on the packet information.

In an aspect, the information management module 1814 sends via the transmission module 1806 timer information associated with the low latency data packet to the modem 1850. In such an aspect, a duration of the data activity timer is determined based on the timer information. In such an aspect, the duration of the data activity timer is greater than or equal to the duration of an inactivity timer set by the host device. In an aspect, expiration of the inactivity timer indicates inactivity in the link for a duration of the inactivity timer and causes the link to transition to the low power state.

The low power state management module 1810 receives from the modem an enable low power message upon expiration of the data activity timer after an end of low latency data communication. The link inactivity timer module 1812 starts an inactivity timer upon receiving the enable low power message. In an aspect, expiration of the inactivity timer indicates inactivity in the link for a duration of the inactivity timer and causes the link to transition to the low power state.

The apparatus may include additional modules that perform each of the steps of the algorithm in the aforementioned flow charts of FIGS. 16 and 17. As such, each step in the aforementioned flow charts of FIGS. 16 and 17 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

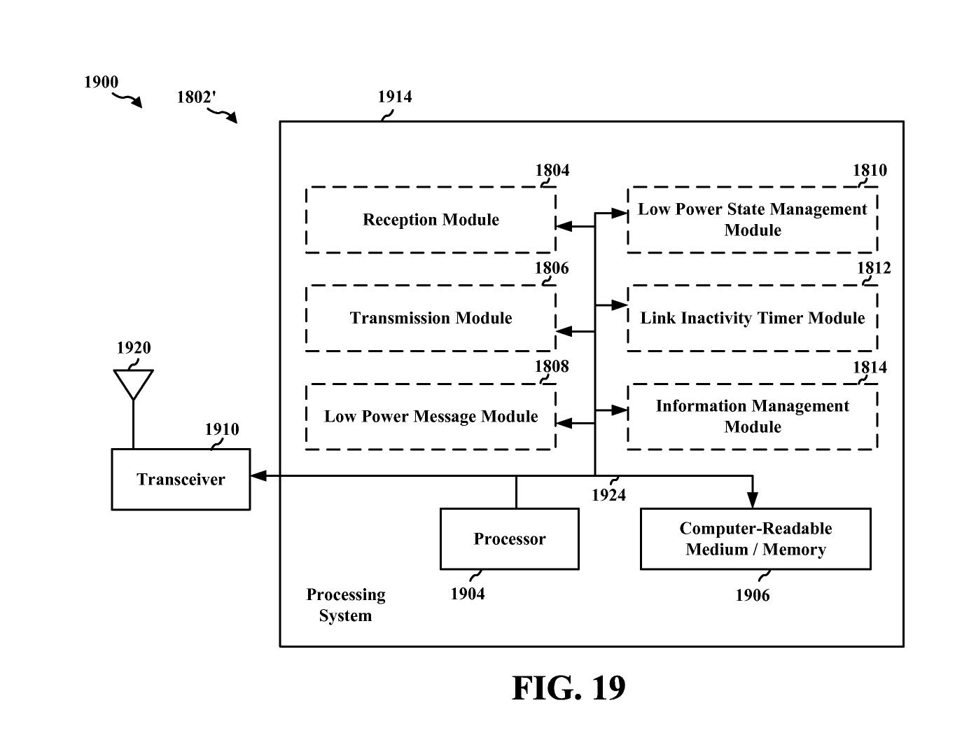

FIG. 19 is a diagram 1900 illustrating an example of a hardware implementation for an apparatus 1802′ employing a processing system 1914. The processing system 1914 may be implemented with a bus architecture, represented generally by the bus 1924. The bus 1924 may include any number of interconnecting buses and bridges depending on the specific application of the processing system 1914 and the overall design constraints. The bus 1924 links together various circuits including one or more processors and/or hardware modules, represented by the processor 1904, the modules 1804, 1806, 1808, 1810, 1812, 1814, and the computer-readable medium/memory 1906. The bus 1924 may also link various other circuits such as timing sources, peripherals, voltage regulators, and power management circuits, which are well known in the art, and therefore, will not be described any further.

The processing system 1914 may be coupled to a transceiver 1910. The transceiver 1910 is coupled to one or more antennas 1920. The transceiver 1910 provides a means for communicating with various other apparatus over a transmission medium. The transceiver 1910 receives a signal from the one or more antennas 1920, extracts information from the received signal, and provides the extracted information to the processing system 1914, specifically the reception module 1804. In addition, the transceiver 1910 receives information from the processing system 1914, specifically the transmission module 1806, and based on the received information, generates a signal to be applied to the one or more antennas 1920. The processing system 1914 includes a processor 1904 coupled to a computer-readable medium/memory 1906. The processor 1904 is responsible for general processing, including the execution of software stored on the computer-readable medium/memory 1906. The software, when executed by the processor 1904, causes the processing system 1914 to perform the various functions described supra for any particular apparatus. The computer-readable medium/memory 1906 may also be used for storing data that is manipulated by the processor 1904 when executing software. The processing system further includes at least one of the modules 1804, 1806, 1808, 1810, 1812, and 1814. The modules may be software modules running in the processor 1904, resident/stored in the computer readable medium / memory 1906, one or more hardware modules coupled to the processor 1904, or some combination thereof. The processing system 1914 may be a component of the UE 650 and may include the memory 660 and/or at least one of the TX processor 668, the RX processor 656, and the controller/processor 659.

In one configuration, the apparatus 1802/1802′ for wireless communication includes means for receiving, at the apparatus, a disable low power message from a modem, where the disable low power message is associated with reception of a low latency data packet, and means for disabling, upon receiving the disable low power message, a low power state of a link between the modem and the apparatus based on a data activity timer, where the data activity timer is determined based on the reception of the low latency data packet. The apparatus 1802/1802′ also includes means for sending filter information to the modem to implement at least one packet filter at the modem, where the data activity timer is determined based on matching between the low latency data packet and a corresponding one of the at least one packet filter at the modem. The apparatus 1802/1802′ also includes means for sending packet information about the reception of the low latency data packet to the modem, where the data activity timer is determined based on the packet information. The apparatus 1802/1802′ also includes means for sending timer information associated with the low latency data packet to the modem, where a duration of the data activity timer is determined based on the timer information. The apparatus 1802/1802′ also includes means for receiving from the modem an enable low power message upon expiration of the data activity timer after an end of low latency data communication, and means for starting an inactivity timer upon receiving the enable low power message, where expiration of the inactivity timer indicates inactivity in the link for a duration of the inactivity timer and causes the link to transition to the low power state. The aforementioned means may be one or more of the aforementioned modules of the apparatus 1802 and/or the processing system 1914 of the apparatus 1802′ configured to perform the functions recited by the aforementioned means. As described supra, the processing system 1914 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
detecting reception of a low latency data packet;
starting a data activity timer determined based on the detection of the reception of the low latency data packet; and
sending a disable low power message from a modem to a host device to disable a low power state of a link between the modem and the host device based on a duration of the data activity timer.

2. The method of claim 1, wherein the detecting the reception of the low latency data packet comprises:
matching the low latency data packet with a corresponding one of at least one packet filter; and
determining packet information on the low latency data packet based on the matching,
wherein the data activity timer is determined based on the determined packet information.

3. The method of claim 2, wherein the at least one packet filter is implemented at the modem based on filter information received from at least one of the host device or a network.

4. The method of claim 2, where the data activity timer is determined by:
determining a packet delay between a previous low latency data packet and the low latency data packet based on the determined packet information,
wherein the data activity timer is determined based on the determined packet delay.

5. The method of claim 4, wherein the duration of the data activity timer is greater than or equal to a duration of the determined packet delay.

6. The method of claim 1, wherein the detecting the reception of the low latency data packet comprises:
receiving, from a host device, packet information about the reception of the low latency data packet,
wherein the data activity timer is determined based on the received packet information.

7. The method of claim 1, wherein the data activity timer is determined by:
receiving timer information associated with the low latency data packet from the host device; and
determining a duration of the data activity timer based on the timer information.

8. The method of claim 7, wherein the duration of the data activity timer is greater than or equal to the duration of an inactivity timer set by the host device, wherein expiration of the inactivity timer indicates inactivity in the link for a duration of the inactivity timer and causes the link to transition to the low power state.

9. The method of claim 1, further comprising:
detecting reception of a subsequent low latency data packet after the reception of the low latency data packet; and
starting a subsequent data activity timer based on the detection of the subsequent low latency data packet.

10. The method of claim 1, further comprising:
detecting an end of low latency data communication;
determining expiration of the data activity timer after the detection of the end of the low latency data transmission; and
sending an enable low power message from the modem to the host device to start an inactivity timer upon expiration of the data activity timer, wherein expiration of the inactivity timer indicates inactivity in the link for a duration of the inactivity timer and causes the link to transition to the low power state.

11. The method of claim 1, wherein the link includes at least one of a peripheral component interconnect (PCI) link, PCI express link (PCIe), universal serial bus link, or a high speed inter chip (HSIC) link.

12. The method of claim 1, wherein the low latency data packet is a quality of service (QoS) data packet.

13. An apparatus of wireless communication, comprising:
means for detecting reception of a low latency data packet;
means for starting a data activity timer determined based on the detection of the reception of the low latency data packet; and
means for sending a disable low power message from the apparatus to a host device to disable a low power state of a link between the apparatus and the host device based on a duration of the data activity timer.

14. The apparatus of claim 1, wherein the means for detecting the reception of the low latency data packet is configured to:
match the low latency data packet with a corresponding one of at least one packet filter; and
determine packet information on the low latency data packet based on the matching,
wherein the data activity timer is determined based on the determined packet information.

15. The apparatus of claim 14, wherein the at least one packet filter is implemented at the apparatus based on filter information received from at least one of the host device or a network.

16. The apparatus of claim 14, where the data activity timer is determined by:
determining a packet delay between a previous low latency data packet and the low latency data packet based on the determined packet information,
wherein the data activity timer is determined based on the determined packet delay.

17. The apparatus of claim 16, wherein the duration of the data activity timer is greater than or equal to a duration of the determined packet delay.

18. The apparatus of claim 13, wherein the means for detecting the reception of the low latency data packet is configured to:
receive, from a host device, packet information about the reception of the low latency data packet,
wherein the data activity timer is determined based on the received packet information.

19. The apparatus of claim 13, wherein the data activity timer is determined by:
receiving timer information associated with the low latency data packet from the host device; and
determining a duration of the data activity timer based on the timer information.

20. The apparatus of claim 19, wherein the duration of the data activity timer is greater than or equal to the duration of an inactivity timer set by the host device, wherein expiration of the inactivity timer indicates inactivity in the link for a duration of the inactivity timer and causes the link to transition to the low power state.

21. The apparatus of claim 13, further comprising:
means for detecting reception of a subsequent low latency data packet after the reception of the low latency data packet; and
means for starting a subsequent data activity timer based on the detection of the subsequent low latency data packet.

22. The apparatus of claim 13, further comprising:
means for detecting an end of low latency data communication;
means for determining expiration of the data activity timer after the detection of the end of the low latency data transmission; and
means for sending an enable low power message from the apparatus to the host device to start an inactivity timer upon expiration of the data activity timer, wherein expiration of the inactivity timer indicates inactivity in the link for a duration of the inactivity timer and causes the link to transition to the low power state.

23. The apparatus of claim 13, wherein the link includes at least one of a peripheral component interconnect (PCI) link, a PCI express link (PCIe), a universal serial bus link, or a high speed inter chip (HSIC) link.

24. The apparatus of claim 13, wherein the low latency data packet is a quality of service (QoS) data packet.

25. An apparatus for wireless communication, comprising:
a memory; and
at least one processor coupled to the memory and configured to:
detect reception of a low latency data packet;
start a data activity timer determined based on the detection of the reception of the low latency data packet; and
send a disable low power message from the apparatus to a host device to disable a low power state of a link between the apparatus and the host device based on a duration of the data activity timer.

26. The apparatus of claim 25, wherein the at least one processor configured to detect the reception of the low latency data packet is configured to:
match the low latency data packet with a corresponding one of at least one packet filter; and
determine packet information on the low latency data packet based on the matching,
wherein the data activity timer is determined based on the determined packet information.

27. The apparatus of claim 26, wherein the at least one packet filter is implemented at the apparatus based on filter information received from at least one of the host device or a network.

28. The apparatus of claim 26, where the data activity timer is determined by:
determining a packet delay between a previous low latency data packet and the low latency data packet based on the determined packet information,
wherein the data activity timer is determined based on the determined packet delay.

29. The apparatus of claim 28, wherein the duration of the data activity timer is greater than or equal to a duration of the determined packet delay.

30. The apparatus of claim 25, wherein the at least one processor configured to detect the reception of the low latency data packet is configured to:
receive, from a host device, packet information about the reception of the low latency data packet,
wherein the data activity timer is determined based on the received packet information.

31. The apparatus of claim 25, wherein the data activity timer is determined by:
receiving timer information associated with the low latency data packet from the host device; and
determining a duration of the data activity timer based on the timer information.

32. The apparatus of claim 31, wherein the duration of the data activity timer is greater than or equal to the duration of an inactivity timer set by the host device, wherein expiration of the inactivity timer indicates inactivity in the link for a duration of the inactivity timer and causes the link to transition to the low power state.

33. The apparatus of claim 25, wherein the at least one processor is further configured to:
detect reception of a subsequent low latency data packet after the reception of the low latency data packet; and
start a subsequent data activity timer based on the detection of the subsequent low latency data packet.

34. The apparatus of claim 25, wherein the at least one processor is further configured to:
detect an end of low latency data communication;
determine expiration of the data activity timer after the detection of the end of the low latency data transmission; and
send an enable low power message from the apparatus to the host device to start an inactivity timer upon expiration of the data activity timer, wherein expiration of the inactivity timer indicates inactivity in the link for a duration of the inactivity timer and causes the link to transition to the low power state.

35. The apparatus of claim 25, wherein the link includes at least one of a peripheral component interconnect (PCI) link, PCI express link (PCIe), universal serial bus link, or a high speed inter chip (HSIC) link.

36. The apparatus of claim 25, wherein the low latency data packet is a quality of service (QoS) data packet.

37. A computer-readable medium storing computer executable code for wireless communication, comprising code for:
detecting reception of a low latency data packet;
starting a data activity timer determined based on the detection of the reception of the low latency data packet; and
sending a disable low power message from a modem to a host device to disable a low power state of a link between the modem and the host device based on a duration of the data activity timer.

38. A method of wireless communication, comprising:
receiving, at a host device, a disable low power message from a modem, wherein the disable low power message is associated with reception of a low latency data packet; and
disabling, upon receiving the disable low power message, a low power state of a link between the modem and the host device based on a data activity timer, wherein the data activity timer is determined based on the reception of the low latency data packet.

39. The method of claim 38, wherein the disabling the low power state of the link comprises:
stopping an inactivity timer to prevent the link from transitioning to the low power state, wherein expiration of the inactivity timer indicates inactivity in the link for a duration of the inactivity timer and causes the link to transition to the low power state.

40. The method of claim 38, further comprising:
sending filter information to the modem to implement at least one packet filter at the modem,
wherein the data activity timer is determined based on matching between the low latency data packet and a corresponding one of the at least one packet filter at the modem.

41. The method of claim 40, wherein the data activity timer is determined based further on a packet delay between a previous low latency data packet and the low latency data packet.

42. The method of claim 41, wherein a duration of the data activity timer is greater than or equal to a duration of the packet delay.

43. The method of claim 38, further comprising:
sending packet information about the reception of the low latency data packet to the modem,
wherein the data activity timer is determined based on the packet information.

44. The method of claim 38, further comprising:
sending timer information associated with the low latency data packet to the modem,
wherein a duration of the data activity timer is determined based on the timer information.

45. The method of claim 44, wherein the duration of the data activity timer is greater than or equal to the duration of an inactivity timer set by the host device, wherein expiration of the inactivity timer indicates inactivity in the link for a duration of the inactivity timer and causes the link to transition to the low power state.

46. The method of claim 38, further comprising:
receiving from the modem an enable low power message upon expiration of the data activity timer after an end of low latency data communication; and
starting an inactivity timer upon receiving the enable low power message, wherein expiration of the inactivity timer indicates inactivity in the link for a duration of the inactivity timer and causes the link to transition to the low power state.

47. The method of claim 38, wherein the link includes at least one of a peripheral component interconnect (PCI) link, a PCI express link (PCIe), a universal serial bus link, or a high speed inter chip (HSIC) link.

48. The method of claim 38, wherein the low latency data packet is a quality of service (QoS) data packet.

49. An apparatus of wireless communication, comprising:
means for receiving, at the apparatus, a disable low power message from a modem, wherein the disable low power message is associated with reception of a low latency data packet; and
means for disabling, upon receiving the disable low power message, a low power state of a link between the modem and the apparatus based on a data activity timer, wherein the data activity timer is determined based on the reception of the low latency data packet.

50. The apparatus of claim 49, wherein the means for disabling the low power state of the link is configured to:
stop an inactivity timer to prevent the link from transitioning to the low power state, wherein expiration of the inactivity timer indicates inactivity in the link for a duration of the inactivity timer and causes the link to transition to the low power state.

51. The apparatus of claim 49, further comprising:
means for sending filter information to the modem to implement at least one packet filter at the modem,
wherein the data activity timer is determined based on matching between the low latency data packet and a corresponding one of the at least one packet filter at the modem.

52. The apparatus of claim 51, wherein the data activity timer is determined based further on a packet delay between a previous low latency data packet and the low latency data packet.

53. The apparatus of claim 52, wherein a duration of the data activity timer is greater than or equal to a duration of the packet delay.

54. The apparatus of claim 49, further comprising:
means for sending packet information about the reception of the low latency data packet to the modem,
wherein the data activity timer is determined based on the packet information.

55. The apparatus of claim 49, further comprising:
means for sending timer information associated with the low latency data packet to the modem,
wherein a duration of the data activity timer is determined based on the timer information.

56. The apparatus of claim 55, wherein the duration of the data activity timer is greater than or equal to the duration of an inactivity timer set by the apparatus, wherein expiration of the inactivity timer indicates inactivity in the link for a duration of the inactivity timer and causes the link to transition to the low power state.

57. The apparatus of claim 49, further comprising:
means for receiving from the modem an enable low power message upon expiration of the data activity timer after an end of low latency data communication; and
means for starting an inactivity timer upon receiving the enable low power message, wherein expiration of the inactivity timer indicates inactivity in the link for a duration of the inactivity timer and causes the link to transition to the low power state.

58. The apparatus of claim 49, wherein the link includes at least one of a peripheral component interconnect (PCI) link, a PCI express link (PCIe), a universal serial bus link, or a high speed inter chip (HSIC) link.

59. The apparatus of claim 49, wherein the low latency data packet is a quality of service (QoS) data packet.

60. An apparatus for wireless communication, comprising:
a memory; and
at least one processor coupled to the memory and configured to:
receive, at the apparatus, a disable low power message from a modem, wherein the disable low power message is associated with reception of a low latency data packet; and
disable, upon receiving the disable low power message, a low power state of a link between the modem and the apparatus based on a data activity timer, wherein the data activity timer is determined based on the reception of the low latency data packet.

61. The apparatus of claim 60, wherein the at least one processor configured to disable the low power state of the link is configured to:
stop an inactivity timer to prevent the link from transitioning to the low power state, wherein expiration of the inactivity timer indicates inactivity in the link for a duration of the inactivity timer and causes the link to transition to the low power state.

62. The apparatus of claim 60, wherein the at least one processor is further configured to:
send filter information to the modem to implement at least one packet filter at the modem,
wherein the data activity timer is determined based on matching between the low latency data packet and a corresponding one of the at least one packet filter at the modem.

63. The apparatus of claim 62, wherein the data activity timer is determined based further on a packet delay between a previous low latency data packet and the low latency data packet.

64. The apparatus of claim 63, wherein a duration of the data activity timer is greater than or equal to a duration of the packet delay.

65. The apparatus of claim 60, wherein the at least one processor is further configured to:
send packet information about the reception of the low latency data packet to the modem,
wherein the data activity timer is determined based on the packet information.

66. The apparatus of claim 60, wherein the at least one processor is further configured to:
send timer information associated with the low latency data packet to the modem,
wherein a duration of the data activity timer is determined based on the timer information.

67. The apparatus of claim 66, wherein the duration of the data activity timer is greater than or equal to the duration of an inactivity timer set by the apparatus, wherein expiration of the inactivity timer indicates inactivity in the link for a duration of the inactivity timer and causes the link to transition to the low power state.

68. The apparatus of claim 60, wherein the at least one processor is further configured to:
receive from the modem an enable low power message upon expiration of the data activity timer after an end of low latency data communication; and
start an inactivity timer upon receiving the enable low power message, wherein expiration of the inactivity timer indicates inactivity in the link for a duration of the inactivity timer and causes the link to transition to the low power state.

69. The apparatus of claim 60, wherein the link includes at least one of a peripheral component interconnect (PCI) link, a PCI express link (PCIe), a universal serial bus link, or a high speed inter chip (HSIC) link.

70. The apparatus of claim 60, wherein the low latency data packet is a quality of service (QoS) data packet.

71. A computer-readable medium storing computer executable code for wireless communication, comprising code for:
receiving, at a host device, a disable low power message from a modem, wherein the disable low power message is associated with reception of a low latency data packet; and
disabling, upon receiving the disable low power message, a low power state of a link between the modem and the host device based on a data activity timer, wherein the data activity timer is determined based on the reception of the low latency data packet.
